(19) United States
(12) Patent Application Publication
(10) Pub. No.: US 2007/0083670 A1
(43) Pub. Date: Apr. 12, 2007

(54) METHOD AND SYSTEM FOR PROTECTING AN INTERNET USER FROM FRAUDULENT IP ADDRESSES ON A DNS SERVER

(75) Inventors: Edward E. Kelley, Wappingers Falls, NY (US); Wayne M. Delia, Poughkeepsie, NY (US); Tijs I. Wilbrink, EN Leiden (NL)

Correspondence Address: WHITHAM, CURTIS & CHRISTOFFERSON, P.C., 11491 SUNSET HILLS ROAD, SUITE 340, RESTON, VA, 20190, US

(73) Assignee: INTERNATIONAL BUSINESS MACHINES CORPORATION, Armonk, NY (US)

(21) Appl. No.: 11/163,225

(22) Filed: Oct. 11, 2005

(51) Int. Cl. G06F 15/16

(52) U.S. Cl. 709/245

(57) ABSTRACT

Domain name system (DNS) servers provide Internet protocol (IP) addresses that computers must have for finding websites on the Internet. A recent problem with navigating the Internet is that hackers have discovered ways to change the IP addresses stored on the DNS servers. An altered IP address will cause an Internet user to be directed to an incorrect or fraudulent website. In the present invention, an Internet user's computer stores domain names and corresponding IP addresses of all websites visited with the computer. Each time a website is accessed, the IP address received from the DNS server is compared to the IP address stored in the database. If the IP addresses are identical, then the newly received IP address is likely legitimate. If the IP addresses are different, then the newly received IP address is likely fraudulent, and the user can be warned before loading the website.

### FIELD OF THE INVENTION

The present invention relates generally to computer security software. More particularly, the present invention relates to a method for preventing Internet user's from being directed to incorrect websites by a domain name system (DNS) server giving false Internet protocol (IP) addresses.

### BACKGROUND OF THE INVENTION

Domain name system (DNS) servers are used in the Internet to translate domain names (or universal resource locators, or URLs), which consist of alphanumeric characters (e.g. such as www.example.com) into Internet protocol (IP) addresses, which consist of four numbers between 1 and 256 (e.g. such as 198.105.232.4). When an Internet user directs an Internet browser to a domain name, the browser must query a DNS server for the corresponding IP address. The browser will then use the IP address to locate and access the desired website. DNS servers are located all over the world and each has a database for translating URLs and domain names into IP addresses. DNS servers are fundamental and essential components of the Internet.

One problem with the DNS server system is that hackers have discovered ways to change the IP addresses stored in DNS servers. By changing the IP address associated with a domain name, a hacker can redirect Internet traffic from a legitimate website to a phony website, even if the proper domain name is used. The hacked DNS server will direct all Internet users to the phony website having the fraudulent IP address. The phony website can then be used for phishing type attacks in which Internet users are fooled into revealing personal financial information, or used for other kinds of criminal activity such as spreading spyware or viruses.

Presently, there is little or nothing an Internet user can do to avoid being directed to a phony website by a hacked DNS server. It would be an advance in the art of Internet security to provide an Internet user the ability to check the validity of IP addresses, and to avoid being directed to phony websites by hacked DNS servers. It would be particularly beneficial to provide protection from corrupted DNS servers that does not require authentication by a remote, third-party computer.

### SUMMARY OF THE INVENTION

The present invention includes a method for authenticating internet protocol (IP) addresses received from a domain name system (DNS) server. In the present method, an Internet user's computer stores a database of IP addresses and domain names. The database can comprise known authentic IP addresses and domain names, or IP addresses and domain names that have been visited by the computer in the past.

When a desired website is accessed, the IP address corresponding to the domain name is received from the DNS server. The received IP address and domain name are compared to entries in the IP address database. If an identical match is found in the database, then the received IP address is considered legitimate. If an entry for the domain name does not match the received IP address, then the received IP address may be fraudulent, and the computer user can be warned.

The IP address database can be loaded on the computer when software is installed, or can be loaded manually, or can be downloaded from secure websites. Alternatively, the IP address database is accumulated over time as new websites are visited.

The present invention also includes a method in which incoming emails are scanned for universal resource locators (URLs). When a URL is detected, the URL is pinged and an IP address is received from the DNS server. The received IP address is then compared with entries in the IP address database.

The present invention also includes a computer system for protecting a computer user from fraudulent IP addresses provided by a compromised DNS server. The computer has a memory, and an IP address database. The IP address database stores a list of domain names and corresponding IP addresses. The computer also includes instructions operable for reading from and writing to the IP address database. The instructions also are operable for comparing received IP addresses received from the DNS server with IP addresses stored in the IP address database. The computer system authenticates received IP addresses by comparing them to entries in the IP address database.

### DESCRIPTION OF THE FIGURES

FIG. 1 shows a computer implementing the present invention in combination with the Internet and domain name system (DNS) server.

FIG. 2 shows an exemplary internet protocol address database.

FIG. 3 shows a flow chart according to the method of the present invention.

FIG. 4 shows a flow chart for a method for authenticating universal resource locators (URLs) received in email messages.

### DETAILED DESCRIPTION

The present invention provides a method and system for authenticating Internet protocol (IP) addresses stored on a domain name system (DNS) server. In the present method, a browser on a user's computer is in communication with an IP address database that stores domain names and IP addresses of websites visited by the computer. As a computer user navigates the Internet and visits websites, IP addresses are stored. Each time the computer navigates to a website previously visited, the IP address received from the DNS server is compared against the database. If the received IP address matches the stored IP address in the database, then the IP address has not changed and the user can be confident that the IP address is legitimate. If the received IP address does not match the stored IP address in the database, then the IP from the DNS server may be fraudulent, or the website associated with the received IP address may be fraudulent, and the user can be alerted. The present method provides a simple and reliable method for protecting Internet users from fraudulent websites and hacked DNS servers.

In the present description, a “ping” is understood to be a network tool that provides a test of whether a particular host or DNS server is operating properly and is reachable over the network. Pinging can also indicate the round trip travel time and packet loss rate. Typically, pinging includes sending a packet to the host or DNS server and waiting for a reply to the packet. When a URL or domain name is pinged, the inquiry packet is sent to a DNS server or server hosting the website associated with the URL.

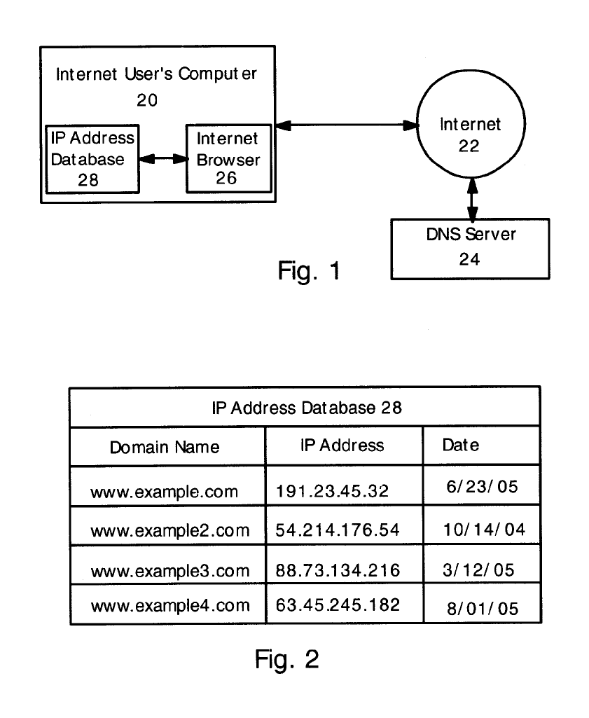

FIG. 1 shows a computer system according to the present invention. The system includes an Internet user's computer 20 that is connected to the Internet 22. The user's computer 20 communicates with a domain name system (DNS) server 24 through the Internet 22. The DNS server 24 provides Internet protocol (IP) addresses to the user's computer 20 as necessary to find websites on the Internet 22. The user's computer 20 includes an Internet browser 26 or other software application for navigating the Internet 22. The Internet browser software is in communication with an IP address database 28 that stores a list of domain names and corresponding IP addresses that have been visited in the past by the user's computer 20, or that have been entered into the database manually or by other methods.

FIG. 2 shows exemplary entries in the IP address database 28. Each entry includes a domain name and corresponding IP address. The database 28 can store all the domain names and all the IP addresses ever visited by the user computer 20. Alternatively, the database 28 can be loaded with popular websites when software is installed. Also alternatively, the database can be filled by manually entering IP addresses and domain names. Optionally, the IP address database includes date and/or time information indicating the last time the corresponding website or IP address was visited, or indicating when the IP address and domain name were entered into the database.

The IP address database is in communication with the Internet browser software 26. In one embodiment, the Internet browser software can write to and read from the IP address database. In another embodiment, the IP address database is static and is preloaded and cannot be changed.

In operation, domain names and corresponding IP addresses visited by the user's computer are stored in the IP address database. Any time a new domain is visited by the computer 20, the domain name and corresponding IP address are entered into the database. Consequently, in one embodiment, the Internet browser software builds the IP address database 28 over time as new websites are visited.

Each time a website is visited, the user's computer 20 receives from the DNS server 24 the IP address corresponding to the visited website. As noted above, the IP address received from the DNS server might be fraudulent due to an attack on the DNS server 24. In order to validate the received IP address, the Internet browser will compare the received IP address with the corresponding IP address stored in the IP address database 28. If the stored IP address and newly-received IP address are the same, then the computer user can be fairly confident that the IP address is correct and has not been hacked. If, on the other hand, the newly-received IP address does not match the IP address stored in the database, then the IP address has changed, and this may indicate that the DNS server has been hacked.

In the case of mismatched IP addresses, the computer user can be alerted to the possibility that the DNS server might be directing the computer user to a fraudulent website. The computer user can attempt to determine the authenticity of the website manually, or by using other more sophisticated authentication techniques. For example, the user may query a third computer (not shown) designed to authenticate websites and IP addresses. The computer user may be offered the option to choose which IP address to visit (i.e. the newly-received IP address or the stored IP address).

Of course, there is not absolute assurance that the IP address stored in the IP address database is the correct IP address for the corresponding domain name. It is possible that the stored IP address is also fraudulent. However, this is unlikely in most cases because typically the IP address data on a DNS server is accurate and a fraudulent IP address typically does not persist for long. Also, more than one DNS server can be queried for IP address information, and, in this case, unless both DNS servers have the same fraudulent IP address, the mismatch will be detected.

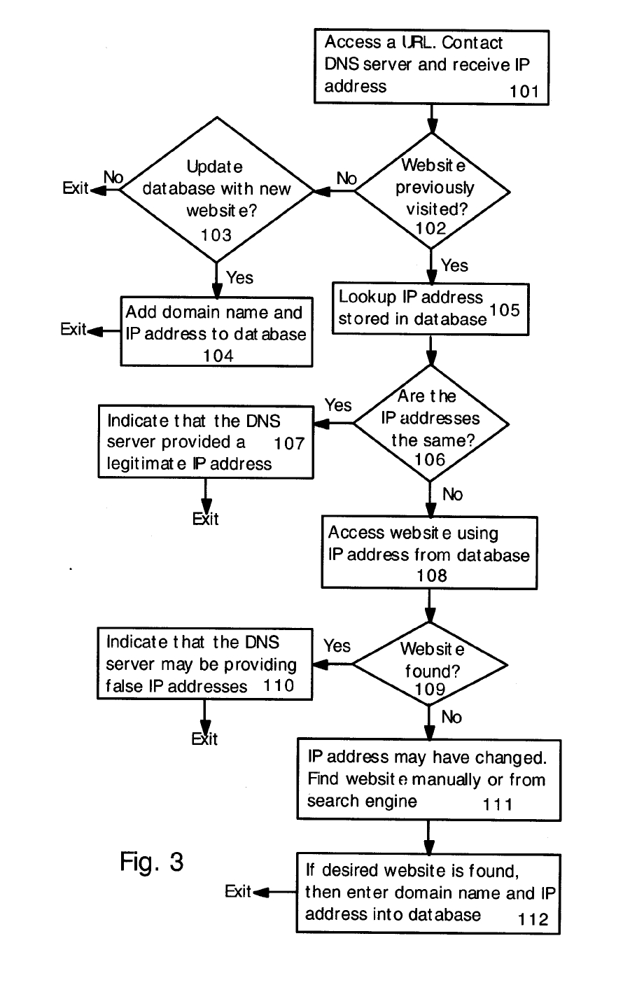

FIG. 3 shows a flow chart illustrating a method of the present invention. The steps 101-112 are described below.

Step 101: An Internet user accesses a website or universal resource locator (URL). Typically, the domain name or URL will be typed into a navigation input of an Internet browser. The URL is “pinged” and a DNS server returns an IP address corresponding to the domain name or URL.

Step 102: The Internet browser software determines if the domain name has been visited in the past or has been preloaded. This can be done by searching the IP address database 28, or by searching a navigation history file.

Step 103: The computer user is asked if the IP address database 28 should be updated with the new domain name and corresponding IP address. This step is optional, as the update to the IP address database can be made automatically or skipped completely.

Step 104: If the domain name has not been visited in the past, and if the computer user desires an update, then the IP address database 28 is updated with the domain name and corresponding IP address received from the DNS server. In order to perform the update, the domain name can be pinged to receive an IP address from a DNS server, as well known in the art. The received IP address may be assumed to be legitimate since it has not been accessed before and it is not present in the database.

Step 105: If the domain name or website has been previously visited, then the corresponding IP address is found in the IP address database.

Step 106: The IP address stored in the database, and the newly received IP address from the DNS server are compared.

Step 107: If the stored IP address and the newly received IP address are identical, then the newly received IP address from the DNS server is probably legitimate. If the IP addresses are identical, then the IP address has not been changed since the most recent access of the domain name. An indication can be provided to the user that the IP address is legitimate, as verified by the local IP address database.

Step 108: If the stored IP address and the newly received IP address are not identical, then the newly received IP address from the DNS server is probably not legitimate. In step 108, the website may be accessed using the stored IP address instead of the IP address received from the DNS server.

Step 109: The website may or may not be found using the IP address stored in the IP address database.

Step 110: If the website is found, then the IP address received from the DNS server should be considered suspect and possibly fraudulent. An indication may be provided to the computer user that the received IP address was likely fraudulent, and that the DNS server may be providing fraudulent IP addresses. Alternatively, Internet security authorities may be automatically notified that the DNS server may be providing incorrect IP addresses.

Step 111: If the website is not found by using the IP address stored in the IP address database, then the legitimate IP address of the website may have changed. The website can be found by other means such as manually or from a search engine for example.

Step 112: If the website is found by other means, then the domain name and IP address of the desired found website can be entered into the IP address database.

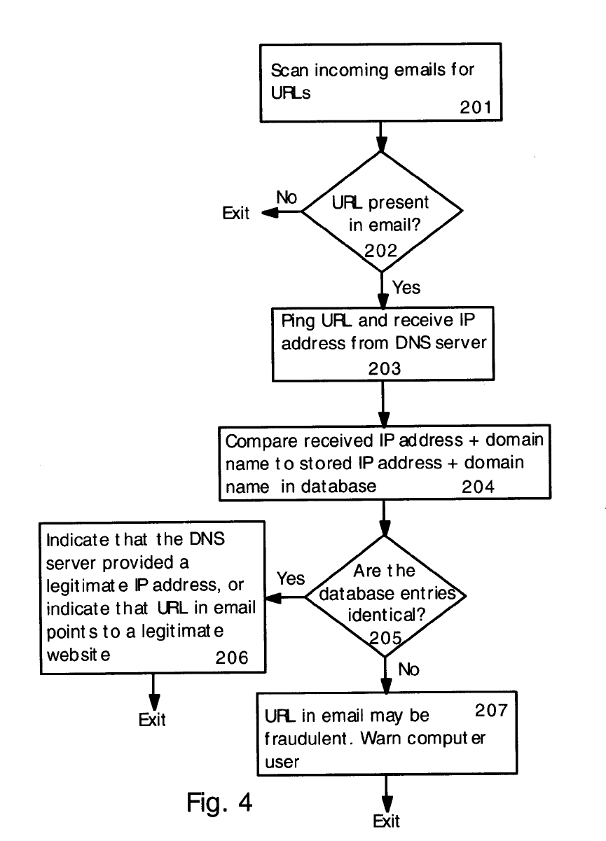

In another aspect of the present invention, illustrated in the flow chart of FIG. 4, the IP address database is used to authenticate URLs received in email messages. Email messages are common vehicles for luring Internet crime victims to fraudulent websites. The present invention provides a way for computer users to be protected from fraudulent websites that employ email messages to attract visitors.

In the present method, email messages are scanned for URLs. When a URL is detected in an email message, the URL is pinged, and the IP address of the URL is provided by a DNS server. The received IP address and domain name of the URL is compared with IP addresses and corresponding domain names stored in the IP address database 28. If an identical domain name and IP address pair are found in the database, then the URL in the email is most likely legitimate. If an identical domain name and IP address are not found in the database, then the URL is likely fraudulent, and the computer user can be notified or warned against visiting the website corresponding to the URL.

The steps of FIG. 4 are described below:

Step 201: Incoming emails are scanned for URLs that direct a computer user to a website.

Step 202: If no URL is detected, then no action is taken.

Step 203: If a URL is detected, then the URL is pinged and the IP address corresponding to the domain name of the URL is received from a DNS server.

Step 204/205: The received IP address and domain name are compared to IP addresses and domain names stored in the IP address database. An identical match of both domain name and IP address is sought.

Step 206: If an identical match is found, then the DNS server likely provided a legitimate IP address and the URL in the email likely directs to a legitimate website. An indication can be provided to the computer user that the URL and website are probably not fraudulent.

Step 207: If an identical match is not found, then the DNS provided an IP address that is likely not legitimate. The computer user can be warned that the URL may direct to an illegitimate or fraudulent website.

In an alternative embodiment of the present invention, the Internet user's computer is provided with an IP address database at the time of purchase or at the time that the Internet browser 26 is installed or updated. Also, the IP address database can be provided as a “plug-in” application for the Internet browser 26. Such a pre-loaded IP address database 28 can include many thousands or millions of known and popular websites. Hence, an Internet user will have a local database of legitimate IP addresses. The pre-loaded database preferably includes domain names and IP addresses for stable corporate, nonprofit, and governmental organizations that are not likely to change or abandon their domain names or IP addresses. In this way, an Internet user will be protected from DNS server hacks that attempt to redirect traffic from popular websites, even if the website has never before been visited by the user's computer.

The present invention provides a method for protecting Internet users from corrupted DNS servers. The present invention operates by comparing IP addresses received from DNS servers with IP address information received in the past, or IP address information known to be legitimate. The present invention allows individual Internet users to maintain and compile a local library of IP address information, and use this library to protect against fraudulent IP addresses supplied by compromised DNS servers.

It will be clear to one skilled in the art that the above embodiment may be altered in many ways without departing from the scope of the invention. Accordingly, the scope of the invention should be determined by the following claims and their legal equivalents.

What is claimed is:

1. A method for authenticating internet protocol (IP) addresses received from a domain name system (DNS) server, comprising the steps of:
a) storing in an IP address database located on an Internet user's computer the IP addresses and corresponding domain names of a plurality of websites;
b) after step (a), receiving from the DNS server a newly received IP address corresponding to a domain name of a desired website;
c) comparing the newly-received IP address with the IP address for the desired website stored in the IP address database.

2. The method of claim 1 wherein step (a) is performed when Internet browsing software is installed on the Internet user's computer.

3. The method of claim 1 wherein a new domain name and corresponding IP address are stored in the IP address database when the Internet user's computer visits a new domain name not present in the IP address database.

4. The method of claim 1 further comprising the step of indicating that the newly-received IP address may be fraudulent if the stored IP address and newly-received IP address are not identical.

5. The method of claim 1 further comprising the step of indicating that the newly-received IP address may be legitimate if the stored IP address and newly-received IP address are identical.

6. The method of claim 1 wherein the IP address database also stores a time of the most recent access of the domain name.

7. The method of claim 1 further comprising the steps of:
1) scanning an incoming email message for universal resource locators (URLs);
2) if a URL is detected, then pinging the URL and performing steps (b) and (c).

8. The method of claim 1 wherein the IP address database is preloaded on the user's computer before the computer is connected to the Internet.

9. A computer system for protecting a computer user from a fraudulent internet protocol (IP) address stored on a domain name system (DNS) server, comprising:
a) a computer having a memory;
b) an internet protocol (IP) address database stored in the memory, wherein the IP address database stores a list of domain names and corresponding IP addresses;
c) software instructions stored in the memory, operable for comparing an IP address stored in the IP address database with a newly received IP address received from the DNS server.

10. The computer system of claim 9 further comprising instructions operable for alerting a computer user that the newly received IP address may be fraudulent if it is not identical to an IP address in the database corresponding to the same domain name.

11. The computer system of claim 9 further comprising instructions operable for alerting a computer user that the newly received IP address may be legitimate if it is identical to an IP address in the database corresponding to the same domain name.

12. The computer system of claim 9 wherein the software instructions are operable for reading from and writing to the IP address database.

13. A method for authenticating universal resource locators (URLs) received in an email message, comprising the steps of:
a) storing in an IP address database located on an Internet user's computer the IP addresses and corresponding domain names of a plurality of websites;
b) scanning an incoming email message for URLs;
c) if a URL is detected, then pinging the URL and identifying the domain name of the URL;
d) receiving from a DNS server a newly received IP address in response to the ping; and
e) comparing the IP address of the domain name corresponding to the URL with the newly-received IP address from the DNS server.

14. The method of claim 13 wherein step (a) is performed when internet browsing software is installed on the Internet user's computer.

15. The method of claim 13 wherein a new domain name and corresponding IP address are stored in the IP address database when the Internet user's computer visits a new domain name not present in the IP address database.

16. The method of claim 13 further comprising the step of indicating that the newly-received IP address may be legitimate if the stored IP address and newly-received IP address are identical.

17. The method of claim 13 further comprising the step of indicating that the newly-received IP address may be fraudulent if the stored IP address and newly-received IP address are not identical.

18. A computer system for protecting a computer user from a fraudulent universal resource locators (URLs) received in an email message, comprising:
a) a computer having a memory;
b) an internet protocol (IP) address database stored in the memory, wherein the IP address database stores a list of domain names and corresponding IP addresses;
c) software instructions stored in the memory, operable for performing the following steps:
1) scanning an incoming email message for URLs and, if a URL is detected, then pinging the URL and identifying the domain name of the URL;
2) receiving from a DNS server a newly received IP address in response to the ping; and
3) comparing the IP address of the domain name corresponding to the URL with the newly-received IP address from the DNS server.

19. The computer system of claim 18 further comprising instructions operable for alerting a computer user that the newly received IP address may be fraudulent if it is not identical to an IP address in the database corresponding to the same domain name.

20. The computer system of claim 18 further comprising instructions operable for alerting a computer user that the newly received IP address may be legitimate if it is identical to an IP address in the database corresponding to the same domain name.

21. The computer system of claim 18 wherein the software instructions are operable for reading from and writing to the IP address database.
